(19) United States
(12) Patent Application Publication
(10) Pub. No.: US 2012/0049692 A1
(43) Pub. Date: Mar. 1, 2012

(54) SYSTEM FOR HARVESTING ENERGY FROM MOTOR VEHICLE SURFACES AND METHODS THEREOF

(76) Inventors: STEPHEN A. BOYD, Manhasset, NY (US); John L. Palumbo, Wyckoff, NJ (US)

(21) Appl. No.: 13/168,246

(22) Filed: Jun. 24, 2011

Related U.S. Application Data
(60) Provisional application No. 61/358,233, filed on Jun. 24, 2010.

(51) Int. Cl. H02N 2/18; E01C 23/00

(52) U.S. Cl. 310/319; 310/339; 404/72

(57) ABSTRACT

Embodiments of the present invention are generally related to a system for harvesting energy from surfaces upon which motor vehicles travel and methods thereof. More specifically, embodiments of the present invention relate to a system and method for harvesting energy by utilizing piezoelectric devices embedded within a roadway or surface, capable of producing electrical power when traversed by a motor vehicle. In one embodiment of the present invention, a system for power harvesting comprises a plurality of piezoelectric devices capable of producing electrical power, a power conditioning unit connected to the piezoelectric devices, and electrical conductors, wherein electrical power is generated when a vehicle traverses over a surface having the plurality of piezoelectric devices therein.

### CROSS-REFERENCE TO RELATED APPLICATIONS

This application claims priority to provisional patent application Ser. No. 61/358,233, filed Jun. 24, 2010, entitled “Energy Harvesting from Motor Vehicle Surfaces,” the disclosure of which is incorporated by reference herein in its entirety.

### BACKGROUND

1. Field of the Invention

Embodiments of the present invention are generally related to a system for harvesting energy from surfaces upon which motor vehicles travel and methods thereof. More specifically, embodiments of the present invention relate to a system and method for harvesting energy by utilizing piezoelectric devices embedded within a roadway or surface, capable of producing electrical power when traversed by a motor vehicle.

2. Description of the Related Art

The piezoelectric effect was first demonstrated by Pierre and Jacques Curie in 1880 using crystals of quartz, tourmaline, topaz, and Rochelle salt, as depicted in FIG. 1. When exposed to mechanical stress, for example, as depicted in FIG. 2, the piezoelectric materials exhibited an electric potential, and the phrase “piezoelectric” was coined.

The reverse piezoelectric effect is, when an electric potential is applied, a predictable deformation of the sample occurs. It was not until 30 years later after the initial discovery made by the Curie brothers that Langevin thought to apply the reverse piezoelectric effect by sandwiching quartz plates (α-quartz) and applying a voltage. FIG. 3 depicts a schematic of the quartz sandwich conceived by Langevin. In this device, an electrical impulse was applied to the quartz creating vibrations of specific frequency. The periodicity of the crystalline deformation is manipulated by applying an alternating electric current (AC) resulting in a predictable periodic deformation of the crystalline lattice. If the AC current is on resonance with the natural resonance frequency of the piezoelectric sample, periodic resonance occurs with significant amplitude. This is one of the first applied technologies of a piezoelectric transducer.

The vibrations from the piezoelectric transducer made by Langevin forced liquid media to vibrate at a specific frequency creating mechanical waves. These mechanical waves would reflect off of objects in the surrounding medium and return to a similar type sensor to “read” the reflected waves indicating their proximity to the sensor. The reflected mechanical waves were read by the sensor by vibrating it, and the resultant voltage from the quartz was interpreted. This technology gave birth to sound navigation and ranging (SONAR) in 1917.

It was around this time that Cady took interest in Langevin's work and developed the first piezoelectric resonator. In 1921 the first applications of piezoelectric materials surfaced as technologies to stabilize radio frequencies emitted from radio transmitters as well as frequency filters.

In 1950, BaTiO₃ became popular as the piezoelectric ceramic of choice in devices such as transducers and capacitors. FIG. 4 depicts a schematic unit cell of the cubic perovskite BaTiO₃. In FIG. 4(a) oxygen is depicted as face centered, whereas in FIG. 4(b), BO₆ octahedra are shown in relation to the unit cell where the oxygen atoms are in edge sharing positions.

Other metal oxides of similar structure, namely of the perovskite family or derivations thereof, have been discovered to exhibit the piezoelectric effect such as, but not limited to, lead titanate (PbTiO₃), lead zirconate (Pb[ZrₓTi₁₋ₓ]O3//0<x<1), and lead lanthanum zirconate titanate (Pb_{0.83}La_{0.17}(Zr_{0.3}Ti_{0.7})_{0.9575}O₃, often abbreviated as PLZT 17/30/70 (where the subscripts 0.17, 0.30, 0.70, etc. denote the stoichiometry of the compound, a.k.a., the dopant level).

A seminal breakthrough occurred in 1969 when the first piezoelectric polymer was discovered in Japan by Heiji Kawai. Poly vinylidene flouride (PVDF) was characterized to have mm2 symmetry as well as piezoelectric constants d₃₁, d₃₂, d₃₃, d₁₅, and d₂₄. As shown in FIG. 5, d₃₃ applies when the electric field is along the polarization axis (direction 3) and the strain (deflection) is along the same axis; and d₃₁ applies if the electric field is in the same direction as before, but the strain is in the direction 1 axis⁸.

Until this point in time, the only polymer films to exhibit piezoelectricity had ∞2 symmetry. In his experiments, Kawai stretched the PVDF films several times at 150° C. then exposed them to a static electric field of 300 kV/cm across the thickness of the film.

For all of these compounds to exhibit the piezoelectric effect, a net polarization must develop in the unit cell, where successive unit cells with the same polarity are known as Weiss domains, exemplified in FIG. 5. In between the Weiss domains, regions where the polarity is broken are called Bloch walls. Through a Bloch wall, which is on the order of a few hundred unit cell dimensions, a new Weiss domain forms that is not necessarily parallel to the other Weiss domains.

To induce an increase in concentration of Weiss domains of the same orientation, often the substance is exposed to a strong electric field resulting in the material exhibiting a stronger piezoelectric response. As shown in FIG. 6, which depicts a schematic of polarization in neighboring domains, no net dipole moment is observed in the schematic on the left; however, in the schematic on the right, a fully developed Weiss domain where the dipole moment across the sample is strongest.

In perovskite structures, when the cation in the center is displaced, a net dipole results. FIG. 7 depicts a piezoelectric crystal PZT, which on the left side, shows the cation is in the center of the unit cell, and on the right side, the cation at the center is displaced creating a net dipole moment as show by the arrow to the left of the Figure.

Piezoelectric materials have been used extensively in sensors, transducers and activators, as well as sensors for structural monitoring, ultrasound transducers, audio application, mechanical motors, instruments for measuring the speed of sound, determining the deformation properties of other materials, ultrasonic technologies, preparation of emulsions, atomizing solutions, remote controllers, medical diagnostic equipment, and the like. FIG. 8 is a more detailed list of known uses of piezoelectric materials. However, despite the numerous benefits of piezoelectric materials, such technology has never been explored in the field of energy harvesting.

Thus, there is a need for a system for harvesting energy from surfaces upon which motor vehicles travel and methods thereof.

### SUMMARY

Embodiments of the present invention are generally related to a system for harvesting energy from surfaces upon which motor vehicles travel and methods thereof. More specifically, embodiments of the present invention relate to a system and method for harvesting energy by utilizing piezoelectric devices embedded within a roadway or surface, capable of producing electrical power when traversed by a motor vehicle.

In one embodiment of the present invention, a system for power harvesting comprises a plurality of piezoelectric devices capable of producing electrical power, a power conditioning unit connected to the piezoelectric devices, and electrical conductors, wherein electrical power is generated when a vehicle traverses over a surface having the plurality of piezoelectric devices therein.

In another embodiment, a method of harvesting energy comprises: embedding a plurality of piezoelectric devices capable of producing electrical power in a road; and connecting a power conditioning unit to the plurality of piezoelectric devices by electrical conductors; wherein electrical power is generated when a vehicle traverses over a surface having the plurality of piezoelectric devices therein.

In yet another embodiment, a method of harvesting energy comprises: embedding a plurality of piezoelectric devices capable of producing electrical power in a tire; and connecting a power conditioning unit to the plurality of piezoelectric devices by electrical conductors; wherein electrical power is generated when the piezoelectric devices within the tire contacts a surface.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a molecular diagram of Rochelle salt, a.k.a., sodium potassium tartrate tetrahydrate, in accordance with one embodiment of the present invention;

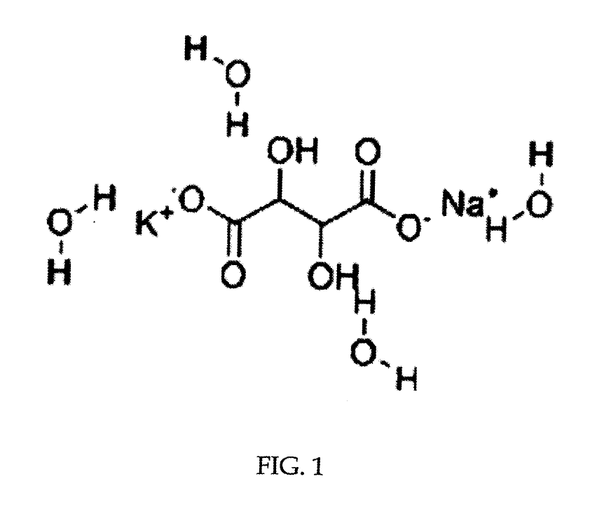

FIG. 2 depicts an illustrative view of schematic representations of the longitudinal (a) direct, (b) converse and (c) shear piezoelectric effects on an element, in accordance with another embodiment of the present invention;

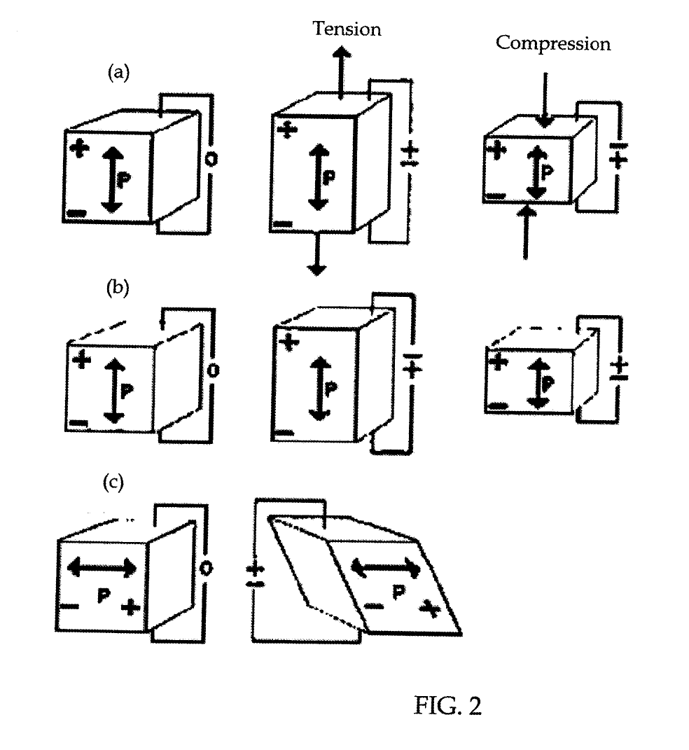

FIG. 3 depicts a schematic of a quartz sandwich in accordance with yet another embodiment of the present invention;

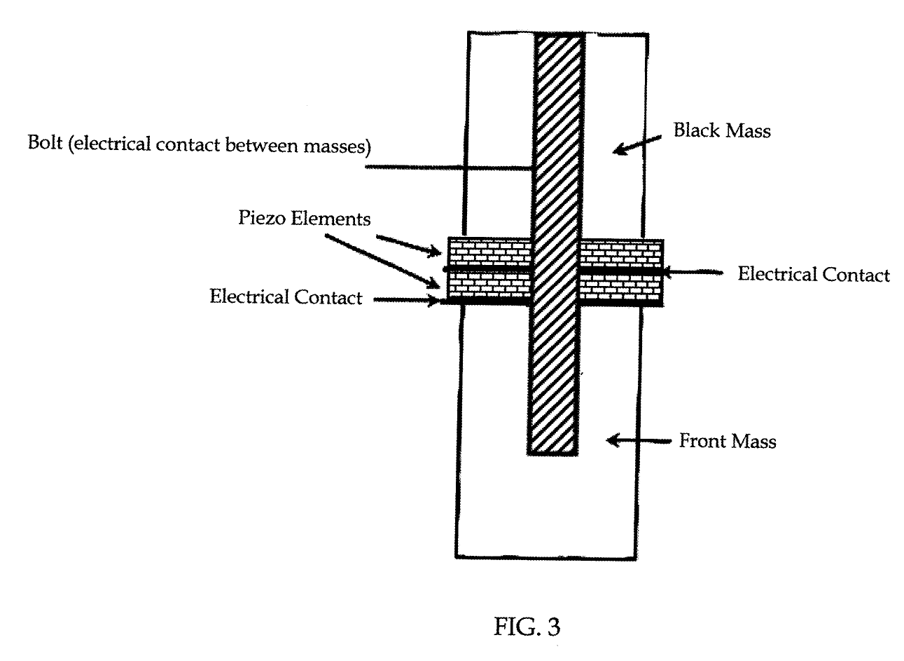

FIG. 4 depicts a schematic unit cell of cubic perovskite, in accordance with an embodiment of the present invention;

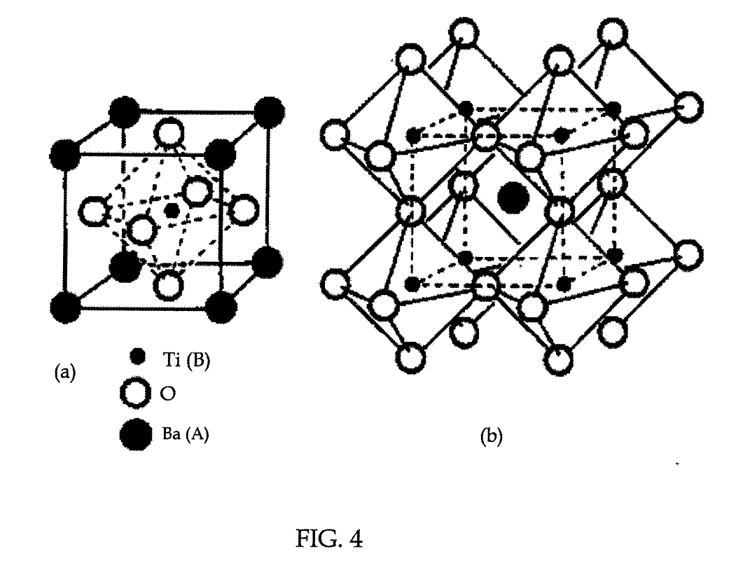

FIG. 5 depicts a schematic of a unit cell showing strain in an electric field, in accordance with an embodiment of the present invention;

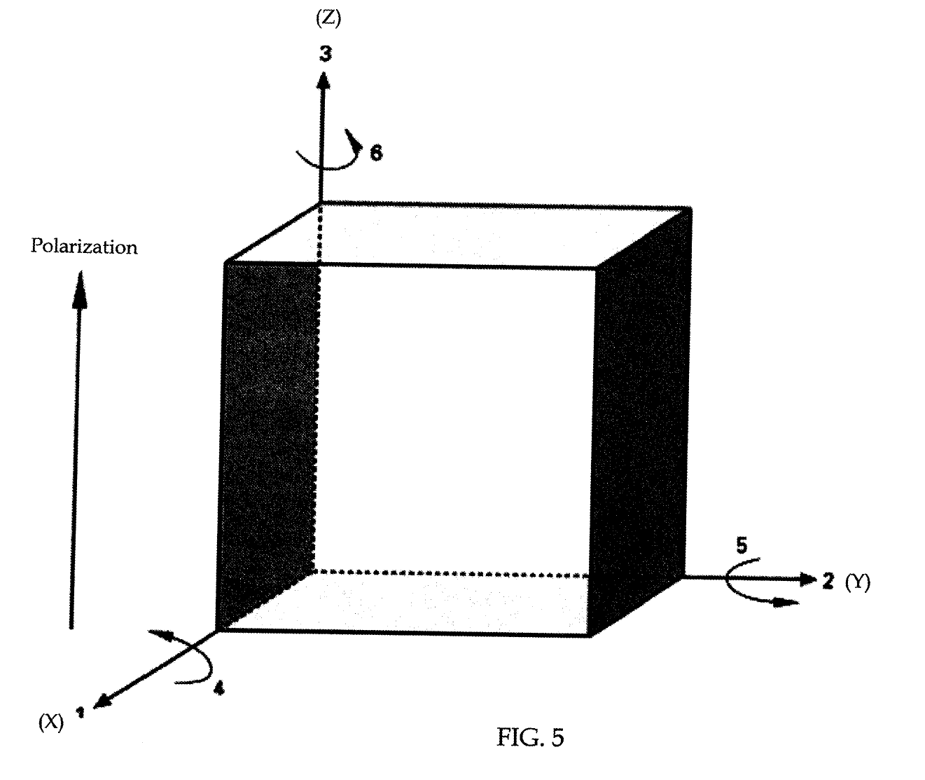

FIG. 6 depicts a schematic of polarization in neighboring domains, in accordance with another embodiment of the present invention;

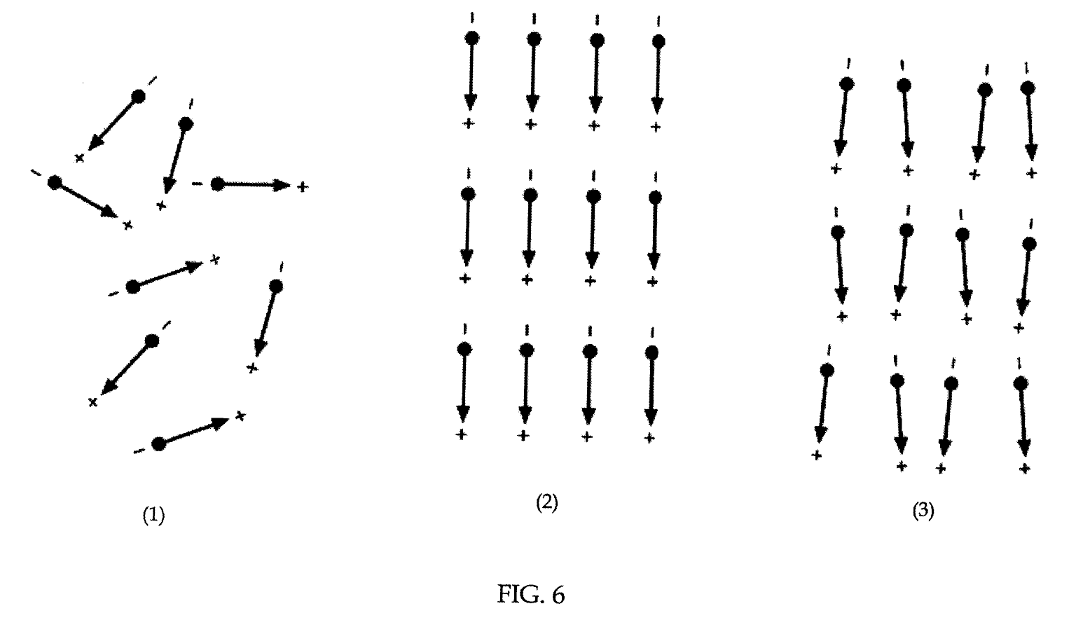

FIG. 7 depicts a schematic of piezoelectric crystal PZT, showing (1) the cation in the center of the unit cell, and (2) the cation at the center being displaced by a net dipole moment, in accordance with yet another embodiment of the present invention;

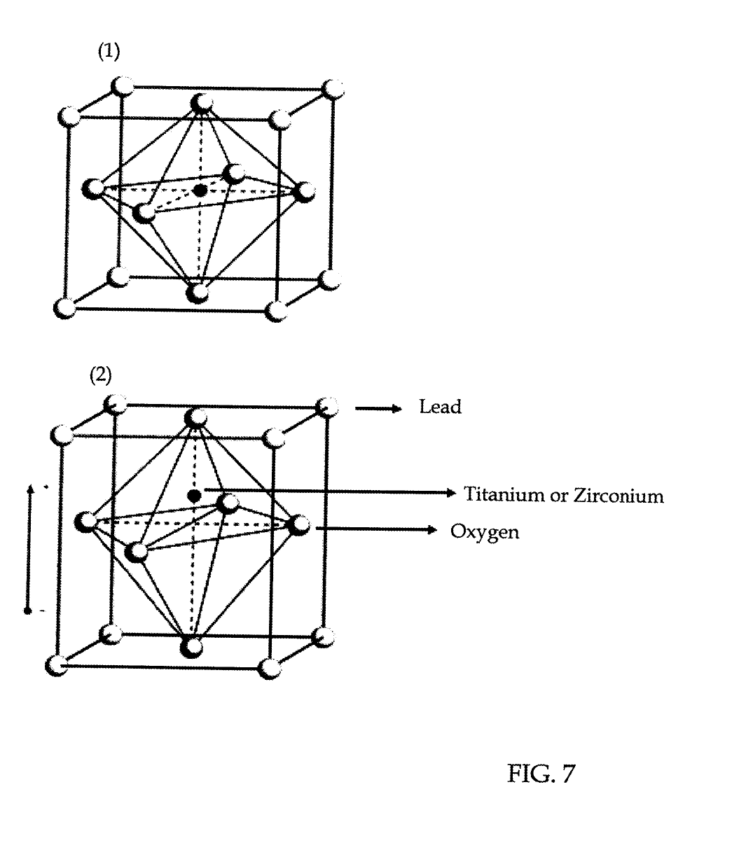

FIG. 8 depicts a flow chart depicting the applications of piezoelectric materials in types of devices, in accordance with embodiments of the present invention;

FIG. 9 depicts a VDF monomer with dipole moment shown as a result of electron density drawn towards the fluorine atoms, in accordance with embodiments of the present invention; and

FIG. 10 depicts a TTTT configuration of PVDF where a 2n momomer repeat unit is shown using the stereochemical convention (left), and the TTTT configurations of the fluorine atoms in perspective (right), in accordance with embodiments of the present invention.

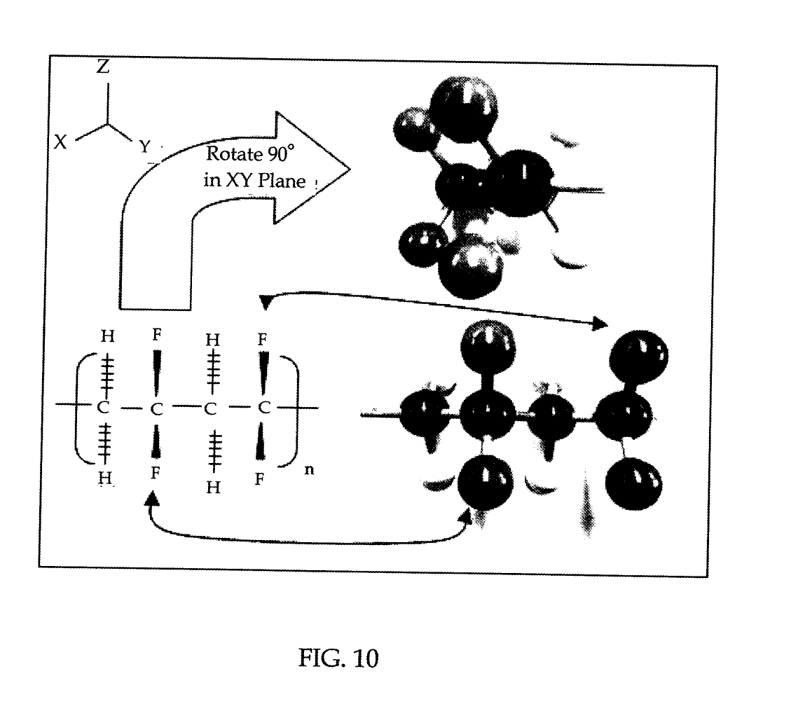

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a system for harvesting energy from surfaces upon which motor vehicles travel and methods thereof. More specifically, embodiments of the present invention relate to a system and method for harvesting energy by utilizing piezoelectric devices embedded within a roadway or surface, capable of producing electrical power when traversed by a motor vehicle.

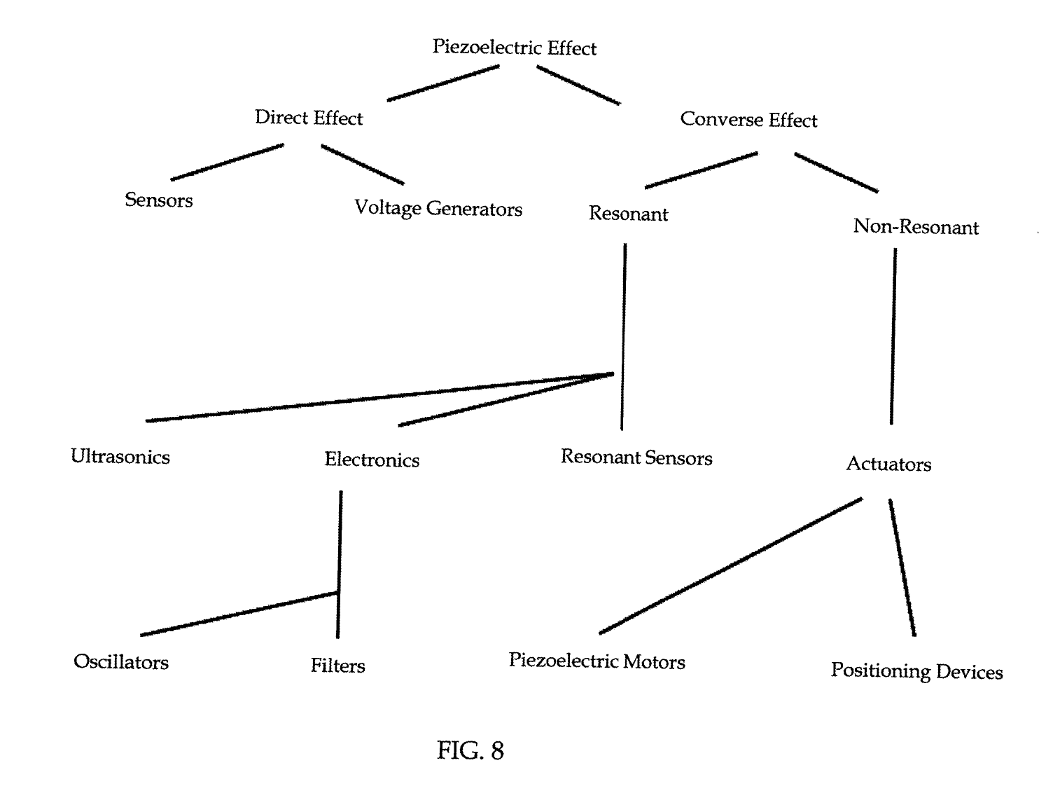

Polyvinylidine difluoride (PVDF) is a polymer chain of chemical formula made from repeating vinylidine difluoride, CH₂-CF₂ (VDF) monomer groups, as shown in FIG. 8. PVDF has been characterized as a semi-crystalline polymer, crystallizing into four different crystalline phases.

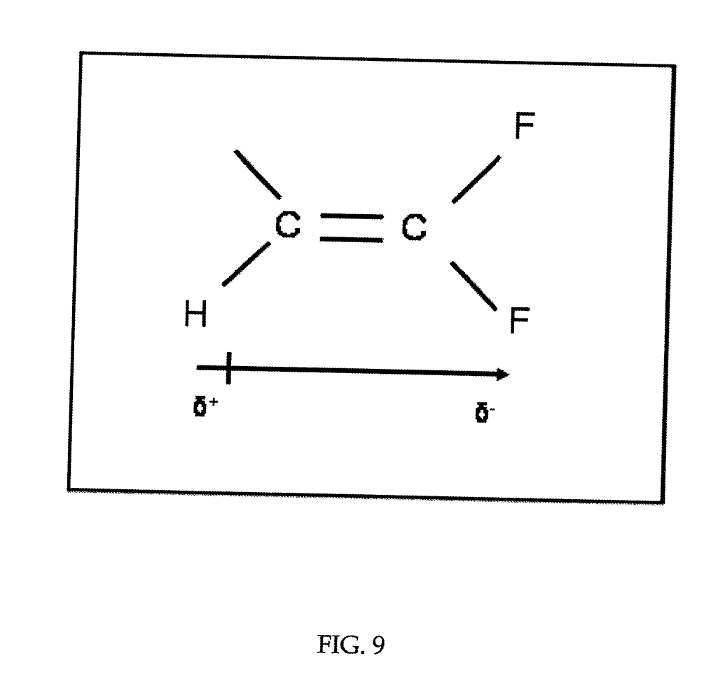

All of the phases have a distinct arrangement of neighboring fluoride atoms; α-PVDF exhibits a TGTG′ (T-trans, G-gauche) arrangement of the next nearest neighboring fluoride atoms; β-PVDF exhibits TTTT conformation with respect to the same fluoride arrangements, as shown in FIG. 9; γ-phase exhibits a TTTG TTG′ arrangement.

Due to the high electronegativity of fluorine and its similar size to hydrogen (1.35 Å vs. 1.2 Å, respectively), electron density is drawn toward the fluoride groups in the polymer chain resulting in a local net dipole moment of magnitude μ=6.4×10⁻³⁰ C·m. The small size of fluorine inhibits ordering of other phases preferring the β phase, whereas substitution of chlorine, for example, induces gamma phase conformations. By increasing the fluorine content in the polymer by use of vinylidiene fluoride/trifluoroethylene (VDF/TrFE) monomers, a gain is had in the net dipole moment of the sample.

However, in accordance with embodiments of the present invention, it has been demonstrated that the β-phase PVDF exhibits piezoelectricity on the order of 6 pC/N, 10 times that of the next highest piezoelectric polymer. In a typical synthesis of PVDF, the α-phase is made via an addition reaction involving VDF monomers, resulting in the α-phase arrangement. The β-phase structure is induced by uniaxial stretching of the material while simultaneously exposing it to static electric fields on the order of 20 kV to 100 MV. Depending of the thickness of the material, heating to below the T_{g} temperature, in addition to exposure to static electric fields, aids in the fabrication of the piezoelectric β-phase.

In one embodiment of the present invention, it has been shown that β-phase PVDF may be synthesized by approximately 2% by weight addition of multi-walled carbon nanotubes (MWNT). In such an embodiment, MWNT was mixed in solution with PVDF powder and precipitated using ethanol as the antisolvent. Wide angle x-ray diffraction (WAXD) confirmed the presence of β-phase PVDF. Thus, embodiments of the present invention yielded a synthesis of piezoelectric β-phase PVDF without the need for uniaxial stretching and poling.

In some embodiments, additives, such as nanoclays and carbon nanotubes may be added to the virgin PVDF polymer and copolymers in solution to induce the β-crystal formation in PVDF. In one embodiment, β PVDF may be synthesized via immersion precipitation technique by adding multi-walled carbon nanotubes (MWNT) at 2.5% by weight, using ethanol as an antisolvent, and again, without the use of uniaxial stretching nor exposure to electric fields.

In further embodiments of the present invention, PVDF polymer powder (e.g., Kynar) may be combined with combinations of any one or more of the following: nanoclays, MWNT, and functionalized MWNT (by the addition of any of the group 1 alkali metals of choice, or other metal cations), as well as copper nanorods (also referred to as “PVDF nanocomposite”) for further optimization of the piezoelectric and or mechanical effects.

Generally, orientation of the crystalline domains of β PVDF is important to electrical energy harvesting and is enhanced by addition of the dopant materials mentioned supra. In one embodiment, the PVDF nanocomposite material may be synthesized and applied to suitable substrate on surfaces (e.g., roadways, streets, highways, pavement, driveways, etc.), to the inner walls of motor-vehicle tires and/or other areas of high traffic volume (including, but not limited to bridges, tunnels, tarmacadam, airport runways, walkways, subway/mass-transit platforms, airplane taxiing/gating areas, sports stadia, pedestrian/motor vehicle surfaces). In many embodiments, it may be advantageous to set the piezoelectric material or device at an angle to the surface.

In another embodiment, a multi-layered thin film, composed of substrate/electrode/PVDF nanocomposite/electrode/sealant layers (referred to as “multi-layered thin film” or “MLTF”) may be deposited onto the roadway surface to harvest electricity by the otherwise wasted mechanical energy of motor vehicles.

The electrode material in the MLTF is appropriately connected, either by either hard wiring or wireless transfer, creating electrical circuitry in parallel, series, and/or combinations thereof, to inverters to maximize the AC output from the DC MLTF input sources. Electrical energy is then fed to a grid in a manner similar to, but not limited to, photo voltaic systems that feed the grid. In specific situations, it may be both energetically and financially warranted to employ storage devices such as nickel/cadmium metal-hydride, lithium-ion, lead-acid, vanadate or other types of secondary batteries, or other high-voltage storage systems such as resistive-mediated capacitor arrays or the like in order to store the electricity for later, modified or alternatively voltage- or frequency-directed usage.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

What is claimed is:

1. A system for power harvesting comprising:
a plurality of piezoelectric devices capable of producing electrical power;
a power conditioning unit connected to the piezoelectric devices; and
electrical conductors;
wherein electrical power is generated when a vehicle traverses over a surface having the plurality of piezoelectric devices therein.

2. The system for power harvesting of claim 1, wherein the power conditioning unit is connected to a main power grid.

3. The system for power harvesting of claim 1, wherein the power conditioning unit is connected to a power storage unit.

4. The system of claim 1, wherein each of the plurality of piezoelectric devices comprise:
a base plate of flexible composite material;
a top plate of flexible composite material;
a plurality of piezoelectric elements capable of producing electrical power positioned between the top plate and the bottom plate; and
an elastic member connecting said base plate and said top plate and excreting compression force on the plurality of piezoelectric elements.

5. A method of harvesting energy comprising:
embedding a plurality of piezoelectric devices capable of producing electrical power in a road; and
connecting a power conditioning unit to the plurality of piezoelectric devices by electrical conductors;
wherein electrical power is generated when a vehicle traverses over a surface having the plurality of piezoelectric devices therein.

6. The method of harvesting energy of claim 5, wherein embedding a plurality of piezoelectric devices comprises:
positioning each of the plurality of piezoelectric devices and the electrical conductors over a concrete base of a road; and
pouring asphalt over said piezoelectric devices and the electrical conductors.

7. The method of harvesting energy of claim 5, wherein embedding a plurality of piezoelectric devices comprises:
pouring a first asphalt layer over a road foundation;
positioning each of the plurality of piezoelectric devices and the electrical conductors over the first asphalt layer; and
pouring a second asphalt layer over the piezoelectric devices and the electrical conductors.

8. The method of harvesting energy of claim 5, wherein embedding a plurality of piezoelectric devices comprises:
embedding each of the piezoelectric devices at an angle to the surface of said road.

9. The method of claim 5, wherein each of the plurality of piezoelectric devices comprise:
a base plate of flexible composite material;
a top plate of flexible composite material;
a plurality of piezoelectric elements capable of producing electrical power positioned between the top plate and the bottom plate; and
an elastic member connecting said base plate and said top plate and excreting compression force on the plurality of piezoelectric elements.

10. A method of harvesting energy comprising:
embedding a plurality of piezoelectric devices capable of producing electrical power in a tire; and
connecting a power conditioning unit to the plurality of piezoelectric devices by electrical conductors;
wherein electrical power is generated when the piezoelectric devices within the tire contacts a surface.

11. The method of claim 10, wherein each of the plurality of piezoelectric devices comprise:
a base plate of flexible composite material;
a top plate of flexible composite material;
a plurality of piezoelectric elements capable of producing electrical power positioned between the top plate and the bottom plate; and
an elastic member connecting said base plate and said top plate and excreting compression force on the plurality of piezoelectric elements.
